(19) United States
(12) Patent Application Publication
(10) Pub. No.: US 2009/0154839 A1
(43) Pub. Date: Jun. 18, 2009

(54) Image processing system having a rapid image processing apparatus and method for image processing

(75) Inventors: Wieland Eckert, Furth (DE); Christian Kordes, Hemhofen (DE); Mario Korner, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/986,859

(22) Filed: Nov. 27, 2007

(30) Foreign Application Priority Data
Nov. 27, 2006 (DE) DE 102006055930.4

(51) Int. Cl. G06K 9/54; G06K 9/00

(52) U.S. Cl. 382/305; 382/128

(57) ABSTRACT

The invention relates to an image processing system having an image processing apparatus. The image processing apparatus comprises at least two image processing units to receive a temporal sequence of image data records forming a common data stream and to generate output image data records from the image data records based on a predetermined allocation specification. The image processing units are connected to one another such that the image processing units are integrated in the common data stream. The image processing apparatus also comprises a shared memory mutually assigned to the image processing units. The shared memory stores the image data records and the output image data records. The image processing units are at least indirectly connected to the shared memory and access the shared memory.

### CROSS REFERENCE TO RELATED APPLICATIONS

This application claims priority of German application No. 10 2006 055 930.4 filed Nov. 27, 2006, which is incorporated by reference herein in its entirety.

### FIELD OF THE INVENTION

The invention relates to an image processing system, in particular a medical image processing system, for processing at least one image data record and a method for image processing.

### BACKGROUND OF THE INVENTION

With medical image processing systems known from the prior art for processing at least one image data record using at least two image processing units, the image processing units are connected to each other such that the image processing units are each integrated into a common data processing stream. A first image processing unit can thus receive an image data record on the input side for instance and generate an output image data record in accordance with a predetermined allocation specification and output said output image data record on the output side to a further image processing unit. The further image processirig unit can receive the output image data record on the input side and generate a further output image data record in accordance with a predetermined allocation specification and output said output image data record on the output side. The predetermined allocation specification can be a filter function for instance, for a highpass filter for location-dependent frequencies, a lowpass filter for location-dependent frequencies or another allocation specification for processing an image, which is represented by an image data record for instance. With this type of image processing, a result of a first image processing step, generated by a first image processing unit, is forwarded to a further image processing unit, in order to experience there a further image processing in accordance with a further predetermined allocation specification.

### SUMMARY OF THE INVENTION

The object underlying the invention is to specify an image processing system with an improved, in particular more rapid image processing.

This object is achieved by an image processing system. The image processing system comprises an image processing apparatus, which comprises an input for at least one image data record, in particular a temporal sequence of image data records. The image data record represents the object in at least two dimensions, in particular in a projection through the object. The image processing apparatus comprises at least two image processing units, with the image processing units each being embodied to receive an image data record and to generate an output image data record from the image data record in accordance with a predetermined allocation specification, said output image data record representing the object in at least two dimensions and outputting the same.

The image processing apparatus comprises a shared memory which is preferably mutually assigned to the image processing units, said shared memory being embodied to store the image data records and the output image data records. Each image processing unit is at least indirectly connected to the shared memory. The image processing units are embodied in each instance so that they have access to a shared memory, in particular read or write access to the shared memory. A higher image processing speed can herewith advantageously be achieved, in particular if the image processing units are each simultaneously able to access the shared memory and all output image data records stored there. An image processing unit can thus access an output image data record which was generated by another processing unit, while the other image processing unit processes an image data record in accordance with the predetermined allocation specification which corresponds hereto.

An image data record can represent the object in two, three, four or five dimensions. In such cases, two or three dimensions may be spatial dimensions, in the event of more than two dimensions, further dimensions may be temporal dimensions. An image data record in the case of four or five dimensions can thus represent the object in three spatial dimensions and in one and/or two temporal dimensions, so that the image data record represents the object, a heart and/or a lung or a thorax for instance, in deformations which differ from each other for instance, as a function of the time. Deformations of the object can be caused for instance by the heartbeat and/or breathing.

An image data record can be formed by a plurality of matrix elements, with a matrix element representing an intensity value of received x-ray beams or an absorption value within a human body, for instance for x-rays, for ultrasound or for a high-frequency magnetic field.

A predetermined allocation specification preferably includes an algorithm, including a number of computing steps. Each computing step can correspond to its own predetermined allocation specification. In this way, the image processing apparatus can advantageously process complex image processing computing operations.

In an exemplary embodiment, the shared memory may be a dynamic or static memory, in particular a D-RAM memory or S-RAM-memory (D-RAM Dynamic Random Access Memory, S-RAM=Static Random Access Memory).

Advantageously, a dynamic memory can be provided cost-effectively.

In a preferred embodiment, at least one image processing unit of the image processing units comprises at least one computing unit, all image processing units also preferably comprise a computing unit in each instance. By way of example, a computing unit can comprise at least one processor, at least one digital signal processor or at least one FPGA (FPGA=Field Programmable Gate Array). The digital signal processor is embodied to execute the predetermined allocation specification by means of a computing process. Advantageously this enables an image processing process to be implemented rapidly. A computing unit is preferably formed by means of at least one part of a processor and embodied so as to generate the further image data record as a result, in accordance with the predetermined allocation specification.

In an advantageous embodiment, the processor is a dual-core or a multi-core processor. By way of example, an image processing unit can be formed at least partially by a processor such that the image processing unit is formed by one core of a dual-core or a multi-core processor.

In another advantageous embodiment, the image processing unit comprises at least two computing units, which are each formed by one core of a dual-core or a multi-core processor. The computing unit preferably includes a controller, in particular formed by a computing program.

In another embodiment, the processor is a cell processor. The cell processor comprises a plurality of computing units, which can each receive an image data record on the input side and can generate an output image data record in accordance with a predetermined allocation specification. In another embodiment, the computing units of the cell processor can process an image data record mutually. Each cell processor, which forms a computing unit, can process one segment of an image data record for instance. In this embodiment, the computing units operate according to the same allocation specification for instance. A predetermined allocation specification can process a part of an image data record as an input parameter, said part representing an object location and thus a pixel in a projection result. In a further preferred embodiment, the allocation specification can also assign an allocation result as a function of an intensity value, represented by a part of the image data record.

The computing units can preferably operate temporally independently and/or temporally in parallel to each other. In an advantageous embodiment, a computing unit is formed by an FPGA (Field Programmable Gate Array). This enables a predetermined allocation specification to be advantageously integrated into the computing unit.

A digital signal processor, a cell processor, or parts of a cell processor, which form a computing unit in each instance, can be controlled by a computing program for instance. The computing program can be controlled by an operating system for instance. The operating system is preferably a multitasking operating system, in particular UNIX, for instance Linux, a real-time operating system, in particular QNX or VxWorks.

In a preferred embodiment, the shared memory comprises a coherent address space. This design jointly assigns the image processing units to the shared memory. Access to the shared memory and thus to the coherent address space can be effected for instance by means of a memory controller or a number of memory controllers. The image processing apparatus can be embodied for instance such that a predetermined part of the coherent address space of the shared memory is assigned to an image processing unit.

In another embodiment, the image processing apparatus comprises two buffer memories, which are each connected to the memory and are provided to read data in/out of the memory. The reading in and/or out can typically take place in such cases according to a principle of double buffering. To this end, the image processing apparatus can be embodied to activate the two buffer memories alternately. The two buffer memories can each be an integral part of the shared memory or form the shared memory. This advantageously allows fast access to the memory to be realized.

In another advantageous embodiment, the shared memory forms a circular buffer, in particular a static circular buffer. The image processing apparatus can be designed to activate a buffer memory of a plurality of buffer memories which is next to be described or to be read, with the plurality of buffer memories collectively forming the circular buffer. This advantageously allows efficient access to the memory to be realized.

In another advantageous embodiment, the image processing apparatus includes a memory controller, which is connected to the shared memory and is embodied to manage a plurality of buffer memories of the shared memory, which collectively form a memory pool. In this embodiment, the memory controller is embodied so as to write an output image data record into a buffer memory from the memory pool. The memory controller can also be embodied to read out the output image data record, which was received by a first image processing unit for instance, from the shared memory, in particular the buffer memory, and to send this to a further, for instance a second image processing unit for further processing purposes. After the successful reading out, the relevant buffer memory can be released from the memory controller for another write operation by another output image data record. The previously described reading out can be carried out for instance by a read access of the second image processing unit. The memory controller can assign the memory pool for a processing step which forms a predetermined allocation specification for instance (private pool) or can assign it for a number of processing steps which form a predetermined allocation specification in each instance (shared pool). In an advantageous embodiment, an item of management information for managing the memory pool can be represented by a predetermined allocation specification, and can thus be advantageously specified by an image processing unit.

The computing units preferably operate according to a mutex method (Mutex=Mutual Exclusion). A mutex method can be formed by semaphores and/or by monitors. It advantageously enables a number of computing units to simultaneously access the shared memory. For example, an output image data record in the shared memory can be blocked by an image processing unit for other image processing units, provided this is still processed.

In another conceivable embodiment, the image processing apparatus comprises at least one memory controller, which is embodied to implement a “mapping” or “paging” of the memory content. This advantageously allows a plurality of image processing units to access the memory simultaneously.

In another embodiment, the image processing system comprises a memory, which comprises a common part which forms the shared memory, in particular a common coherent address space and additionally comprises a private part, in particular a private address space. A private address space of the memory, or a plurality of private address spaces of the memory can preferably be organized such that a private address space is assigned to an image processing unit.

In a preferred embodiment, the image processing unit comprises at least one computing unit, which is embodied so as to generate the output image data record in accordance with the predetermined allocation specification. In an advantageous embodiment, an image processing unit can comprise at least two, preferably a number of computing units. The computing units can each operate according to the same allocation specification. The computing units of an image processing unit can preferably operate temporally in parallel to each another. This allows each computing unit to process a part of an image data record for instance.

In a preferred embodiment, the image processing apparatus comprises at least one cache memory, which is in particular coherently assigned to the shared memory. A more rapid reading into/out of the shared memory can advantageously take place by means of a cache memory.

In an advantageous embodiment, the image processing apparatus comprises a plurality of cache memories. By way of example, each image processing unit can comprise two cache memories, in particular a cache memory for writing and a cache memory for reading. The image processing apparatus can be embodied, in particular by means of a memory controller, to coherently retain memory contents of the shared memory and the cache memory in respect of each other.

In a preferred embodiment, the image processing apparatus comprises a memory controller, with the image processing units each being connected to the memory by means of the memory controller. In an advantageous embodiment variant, the image processing units, in particular the computing units of the image processing units, are each embodied so as to access the shared memory at least indirectly, preferably by means of the memory controller, by means of at least one rapid block transfer, in particular by means of DMA, (DMA=Direct Memory Access). It is also preferable for the image processing apparatus to be embodied, in particular controlled by a computing program, so as to store and/or release a memory area of the shared memory into a private memory area. The shared memory is preferably organized as a coherent address space.

In an advantageous embodiment, the connection of the image processing units, in particular the processors with the shared memory, is formed in each instance by a remote DMA system. To this end, the connection of the image processing units, preferably the processors, to the shared memory, can advantageously comprise a high-speed channel, in particular an infini-band-channel, a hyper-transport-channel, a fiber-channel, an Ethernet-channel or a rapid-I/O-channel at least in sections.

In an advantageous embodiment variant, the image processing apparatus can comprise a plurality of memories, which collectively form the shared memory. The image processing apparatus in this embodiment preferably comprises a memory controller, which is embodied so as to store and release memory contents by means of block transfers and to access the memory by means of remote DMA (RDMA=Remote Direct Memory Access).

The memory controller is preferably connected to the plurality of memories which form the shared memory by means of at least one high-speed channel. Exemplary embodiments of a high-speed channel include a hyper transport channel or an infini band channel. Alternatively, a high-speed channel can be formed by a future-I/O-channel, a Next-Generation-I/O-channel, a Fiber-channel, an Ethernet-channel or a Rapid-I/O-channel. A high-speed channel advantageously enables a computing program, such as with a DMA memory organization, to access the plurality of memories which form the shared memory.

In a preferred embodiment, the detection device comprises at least two memory units which form the shared memory and memory controllers assigned hereto, with the memory units each being connected to an image processing unit by means of the assigned memory controllers, and with the assigned memory controller being at least indirectly connected to one another. In this embodiment variant, the shared memory can be advantageously formed by at least two, advantageously a number of memory modules which differ from each another. By way of example, the memory controller is embodied so as to access a memory, in particular at least indirectly, in accordance with a remote DMA method.

In an advantageous embodiment variant, the image processing system comprises at least two memory units which form the shared memory and memory controllers assigned hereto, with the memory units each being connected to an image processing unit by means of the assigned memory controller in each instance, with the image processing units being at least indirectly connected to each other. In this embodiment variant, the shared memory can be formed by at least two, preferably a number of memory modules which differ from each other. By way of example, the image processing units can be connected to each other by means of a high-speed channel in each instance. A first image processing unit can access the memory module connected to the memory controller by way of the high-speed channel and by way of a second image processing unit connected hereto via the memory controller assigned to the second image processing unit.

In an advantageous embodiment, the shared memory is connected to the image processing units in accordance with to a NUMA architecture (NUMA=Non-Uniform Memory Access). In this embodiment, the shared memory can be advantageously formed by a number of memory units, in particular memory modules. In this embodiment, the memory units preferably collectively form a shared coherent address space. The NUMA architecture can be formed for instance by a corresponding embodiment of a memory controller and/or a computing program. A NUMA architecture advantageously enables a shared memory, preferably with a coherent address space, to be formed by a memory of computing units which differ from each other. In an advantageous embodiment of an image processing system with a NUMA architecture, the image processing apparatus comprises a cell processor, which comprises a plurality of computing units. The computing units can be assigned in each instance to an image processing unit or form an integral part of an image processing unit.

The computing units can be arranged at a distance from one another for instance. By way of example, a computing unit is formed by a blade of a blade server.

In another embodiment, the computing units can collectively be assigned to an image processing unit or can collectively form an integral part of an image processing unit. In this embodiment, the shared memory preferably comprises a coherent address space, as a result of which a uniform, logical addressing can be advantageously ensured. In an advantageous embodiment, the computing units can each comprise a processor, in particular a DSP (DSP Digital Signal Processor), which are each connected to one another. The connection between the processors can form an integral part of a NUMA architecture.

In an advantageous embodiment, a processor, in particular a cell processor with computing units which differ from one another, can be heterogeneously connected to one another and embodied such that a first computing unit can implement a function of a central processing unit (CPU=Central Processing Unit), where by contrast further computing units are activated in each instance by the central computing unit and a calculation can be implemented in accordance with a predetermined allocation specification as a function of a control signal emitted by the central processing unit. The computing units of a processor, in particular a cell processor with a heterogeneous organization structure, can comprise computing units which are identical to one another or computing units which are different to one another.

In a simple embodiment variant, a processor, in particular a cell processor, can be embodied as an SMP processor (SMP=symmetrical multiprocessor). The computing units of a processor can operate according to predetermined allocation specifications which differ from one another.

To this end a computing unit can comprise a memory for storing the predetermined allocation specification. The image processing units, in particular the computing units, are preferably embodied so as to operate according to a predetermined allocation specification. The predetermined allocation specification can be stored in the memory provided herefor. In another embodiment, the memory for the predetermined allocation specification is a write/read memory and the image processing apparatus is embodied so as to allocate a predetermined allocation specification and to an image processing unit to store a corresponding data record in the memory for the predetermined allocation specification. The image processing apparatus can also preferably be embodied, as a function of the time or as a function of a process status, to assign a predetermined allocation specification to an image processing unit. The image processing apparatus can in this way advantageously distribute dynamic processing processes, in particular image processing processes onto the image processing units. In the event of a static allocation of a predetermined distribution specification to an image processing unit, advantageous deterministic statements relating to the temporal behavior of the image processing apparatus can advantageously be made. In the event of a dynamic allocation, the image processing units available, in particular the computing units, can be utilized better during a time interval, since an image processing unit is not exclusively provided for a predetermined allocation specification.

In a preferred embodiment, a computing unit has a computing speed of at least 10 giga operations, further preferred at least 100 giga operations, further preferred at least 1000 giga operations per second. An operation can be a floating-point operation or an integer operation.

The previously described embodiment variants for an image processing apparatus of an image processing system can advantageously access an intermediate result, represented by an output image data record, while another image processing unit which processes a preceding processing stage is still operating. A coupling of the image processing units by way of the shared memory is also advantageous, since an image processing unit can also operate the shared memory in this way, whereas another image processing unit which processes a subsequent processing stage is already able to read out from the same shared memory, in particular the same memory area. A response time of a system formed by the image processing apparatus can herewith be advantageously shortened. A shared memory can be a static (SRAM=Static Random Access Memory) or a dynamic memory (DRAM=Dynamic Random Access Memory).

The invention also relates to a method for image processing at least one image data record, in particular a temporal sequence of image data records, which each represent an object detected in at least two dimensions, with the image processing being carried out in at least two processing stages, in which an output image data record is generated from an image data record and/or an output image data record in accordance with a predetermined allocation specification.

With the method, the at least one image data record and the output image data record are advantageously stored in a shared memory, and with each processing stage, said image data record is read out of the shared memory and written into the shared memory. Advantageously this allows a high image processing speed to be achieved.

The image data record can be generated by means of an imaging method for detecting an object. By way of example, the image data record can be generated by an x-ray apparatus, in particular an x-ray C-arm device, a computer tomograph, a magnetic resonance tomograph or an ultrasound detection device.

In accordance with the invention, an image processing system of the afore-described type can advantageously form an integral part of a detection system for detecting an object in at least two dimensions. The detection system advantageously comprises a detection device, which is designed to detect the object in at least two dimensions and to generate an image data record, which represents the object in at least two dimensions. By way of example, the detection device is an x-ray apparatus, an x-ray C-arm device, a magnetic resonance tomograph, a computer tomograph or an ultrasound detection device. The input of the image processing apparatus of the detection system is connected to the detection device.

### BRIEF DESCRIPTION OF THE DRAWINGS

The invention is now described in more detail with reference to figures and further exemplary embodiments, in which;

FIG. 1 shows a schematic exemplary embodiment of an image processing system and

FIG. 2 shows schematic exemplary embodiments of an image processing apparatus.

### DETAILED DESCRIPTION OF THE INVENTION

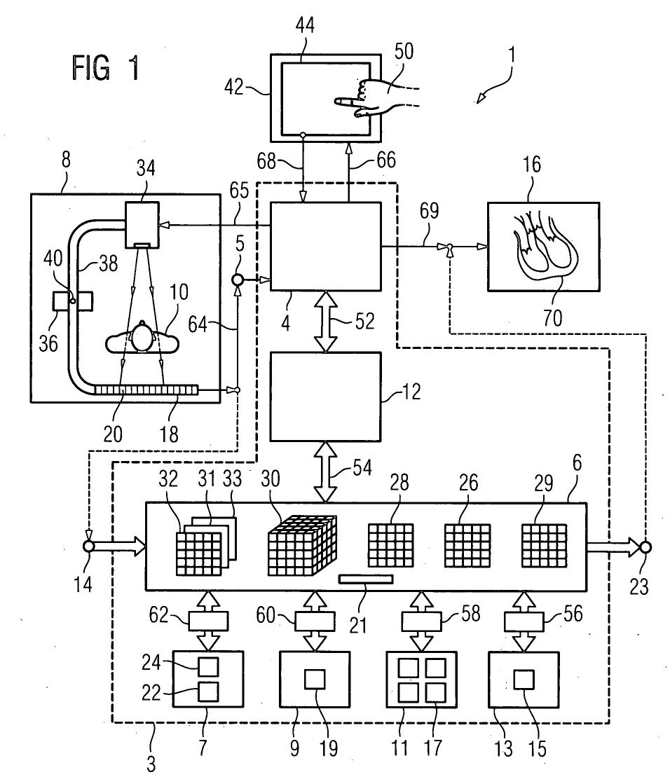

FIG. 1 shows a schematic representation of an exemplary embodiment of an image processing system 1 with an image processing apparatus 3, which comprises an input 5 for at least one image data record. The image processing system 1 also comprises a shared memory 6 and is connected to a detection device 8 for detecting an object 10 in a projection through an object on a detection plane. The detection device 8 is connected on the output side with the input 5 for an image data record and is embodied so as to generate an image data record by means of x-rays, said image data record representing the object 10 in a projection through the object. To this end, the detection device 8 comprises an x-ray emitter 24, a detector 18 arranged in the detection plane and a C-arm 38, which is connected to the x-ray emitter 34 and the detector 18. The C-arm 38 is connected to a control device 36 by way of a shaft 40, said control device 36 being embodied to pivot the C-arm 38 and thus the x-ray emitter 34 and the detector 18 about the object 10. The detector 18 comprises a plurality of detector matrix elements, which are each embodied to detect x-rays and to generate an output signal, which represents an intensity of the detected x-rays. The detector matrix element 20 is indicated by way of example. The detection device 1 also comprises a central processing unit 4. The image processing system 1 also comprises an image processing unit 7, an image processing unit 9, an image processing unit 11 and an image processing unit 13. The image processing system 1 also comprises a memory controller 12, which is connected to the central processing unit 4 by way of a bidirectional data bus 52 and is connected to the shared memory 6 by way of a bidirectional data bus 54. The image processing unit 13 comprises a computing unit 15, the image processing unit 11 comprises a number of in this exemplary embodiment, four computing units, of which computing unit 7 is indicated by way of example. The image processing unit 9 comprises a computing unit 19. The image processing unit 7 comprises a computing unit 22 and a computing unit 24. The shared memory 6 is embodied so as to store image data records, which represent the object in two or three dimensions in each instance. The image data records 26, 28, 31, 32 and 33 are shown by way of example. A 3D image data record 30 is shown by way of example, which is generated from a plurality of image data records, for instance from the image data records 31, 32, 33, which represent the object 10 in a projection through the object 10 in two dimensions in each instance, in particular in detection directions which differ from each other.

The image processing system 1 also comprises an input unit 42 having a touch-sensitive surface 44, which is embodied as an image reproduction unit. The touch-sensitive surface is embodied, as a function of a contact, by the hand of a user 50 for instance, to generate a user interaction signal, which represents a point of contact of the contact of the touch-sensitive surface 44. The image processing unit 13 is connected to the shared memory 6 by way of a memory controller 56. The image processing unit 11 is connected to the shared memory 6 by way of a memory controller 58. The image processing unit 9 is connected to the shared memory 6 by way of a memory controller 60 and the image processing unit 7 is connected to the shared memory 6 by way of a memory controller 62.

The central processing unit 4 is connected to the input 5 on the input side for at least one data record. The central processing unit 4 is also connected to the image reproduction unit of the input unit 42 on the output side by way of a connecting line 66 and is connected to the touch-sensitive surface 44 on the input side by way of a connecting line 68. The central processing unit 4 is connected to the x-ray emitter 34 on the output side by way of a connecting line 65. The detector 18 of the detection device 8 is connected to the input 5 on the output side by way of a connecting line 64. The central processing unit 4 is connected to an image reproduction unit 16 of the image processing system 1 on the output side by way of a connecting line 69. A heart 70 of the object 10, in this exemplary embodiment a patient, is reproduced by way of example by the image reproduction unit 16.

The mode of operation of the image processing system 1 is now described below.

The central processing unit 4 can generate a detection signal for detecting the object 10 by means of the detection device 8 as a function of a user interaction signal received by way of the connecting line 68, generated by the hand of a user 50 for instance, and can transmit said detection signal on the output side via the connecting line 65 to the detection device 8 and there to the x-ray emitter 34. The detection device 8 is embodied so as to detect the object 10 as a function of the detection signal received by way of the connecting line 65 by means of the detector 18 and by means of x-rays generated by the x-ray emitter 34 in a projection through the object and to generate an image data record, which represents the object 10 in two dimensions of a projection through the object and output this via the connecting line 64 to the input 5. The central processing unit 4 can receive the image data record via the input 5 on the input side and transmit said image data record to the memory controller 12 by way of the bidirectional data bus 52. The memory controller 12 can store the image data record in the shared memory 6 by way of the bidirectional data bus 54. The image data record is shown there by way of example as an image data record 32. The image data record 32 represents a projection through the object 10 in two dimensions and in an image matrix, which is formed from a plurality of image matrix elements, with each image matrix element corresponding to an intensity value of received x-rays, or corresponding to an absorption value of a corresponding object area of the object 10. In this case, the image matrix corresponds to a detector matrix of the detector 18.

The image processing unit 7 is able to read the image data record 32 from the shared memory 6 by way of the bidirectional data bus 62, to generate a further image data record in accordance with a predetermined allocation specification and to store this as an image data record 28 in the shared memory 6 by way of the memory controller 62 for instance. The predetermined allocation specification is a folding operation for instance, in particular a folding operation which corresponds to a highpass location frequency filtering. The image processing unit 9 can readout the output image data record 28 from the shared memory 6 by way of the memory controller 60 for instance, and can implement an image processing step in accordance with a predetermined allocation specification, by means of the computing unit, in particular a digital signal processor. The predetermined allocation specification can be a folding operation for instance, in particular a folding operating with a Sobel operator, so that an output image data record comprises a projection through the object 10 with enhanced object edges. The image processing unit 9 is able to store the thus generated output image data record in the shared memory 6 as an output image data record 26 by way of the memory controller 60. Alternatively to the output image data record 28 generated by the image processing unit 7, the image processing unit 9 can process the image data record 32 as input data in accordance with predetermined allocation specification for instance. The image processing unit 11 comprises four computing units, which can each be embodied for instance as a digital signal processor, and of which the computing unit 17 is indicated by way of example. The computing units of the image processing unit 11 can be formed collectively for instance by a cell processor or a multi core processor, unlike previously described. In this exemplary embodiment, the image processing unit 11 can generate a 3D image data record from a temporal sequence of image data records, which represent the object 10 in a projection through the object 10 in detection directions which differ from each other, said 3 D image data record representing the object 10 in three dimensions. To this end, the image processing unit 11 can process a plurality of image data records, received on the input side, in accordance with a predetermined allocation specification, according to a filtered back projection for instance and can generate the 3D image data record as processing result of the predetermined allocation specification. The 3D image data record can represent a plurality of voxel object points, which each represent an object location, in particular an absorption value for the x-rays of an object location. In this exemplary embodiment, the computing units of the image processing unit 11 can simultaneously operate image areas of an image data record which differ from one another in accordance with the same allocation specification. The computing units 22 and 24 of the image processing unit 7 can be formed for instance as digital signal processors, which can simultaneously process image areas of an image data record which differ from one another. By way of example, the computing units 22 and 24 can be formed for instance by a dual-core processor.

The image processing unit 11 is able to send the 3D image data record generated by means of filtered back projection to the shared memory 16 by way of the memory controller 58 and to store it there as a 3D image data record 30. A gradual generation of the 3D image data record 30, in which the image processing unit 11 gradually generates the 3D image data record 30, is also conceivable, and after a processing step, overwrites an area of the 3D image data record 30 with a new allocation result. Image data records 31 and 33 are also shown, which, together with the image data record 32, are able to form a temporal sequence of image data records, which represent the object 10 in the same detection direction or in detection directions which differ from one another in each instance. A cache memory 21 is also shown as part of the shared memory 6. The image processing unit 11, the image processing unit 7 or the image processing unit 9 can buffer an image data record or parts of an image data record, to which temporally successive computing operations are applied, in the cache memory 21, and thus store it for rapid access purposes.

The image processing unit 13 comprises a computing unit 15, which can be embodied as a digital signal processor for instance. The image processing unit 13 can receive the image data record 32, the output image data record 28 or the output image data record 26 via the memory controller 56 on the input side and can process the same in accordance with a predetermined allocation specification which corresponds for instance to a lowpass filtering for noise suppressions and can generate an output image data record 29 as a processing result of the predetermined allocation specification and store this in the shared memory 6 by way of the memory controller 56. The predetermined allocation specification for lowpass filtering can correspond for instance to a folding operation, in particular a folding of the image data record received on the input side with a delta impulse or with a rectangular impulse.

The central processing unit 4 can readout the output image data record 29 using the memory controller 12 by way of the bidirectional data bus 54 and the bidirectional data bus 52 from the shared memory 6 and transmit it via the connecting line 69 to the image reproduction unit 16 for reproduction purposes by means of the image reproduction unit 16. The image reproduction unit 16 reproduces a heart 70 in this exemplary embodiment, which is represented by an image processing result of the image processing unit 3. The image processing unit 7, 9, 11 and 13 can each simultaneously access the shared memory 6, so that the image processing apparatus 3 is able to very efficiently transmit a data stream which is formed by image date records and received at the input 5 of a data source, formed by the detection device 8, at a data sink, formed by means the image reproduction unit 16.

Independent of or in addition to the input 5, the shared memory 6 can comprise an input 14 for at least one image data record and an output 18 for outputting at least one image data record. The input 14 is, shown by a dashed line, actively connected to the detector 18. The output 23 is, shown by a dashed line, actively connected to the image reproduction unit 16. The image processing units 7, 9, 11 and 13 can each access the shared memory independently of one another. Access to the shared memory by the image processing units 7, 9, 11 and 13 which is controlled by the central processing unit 4 is also conceivable.

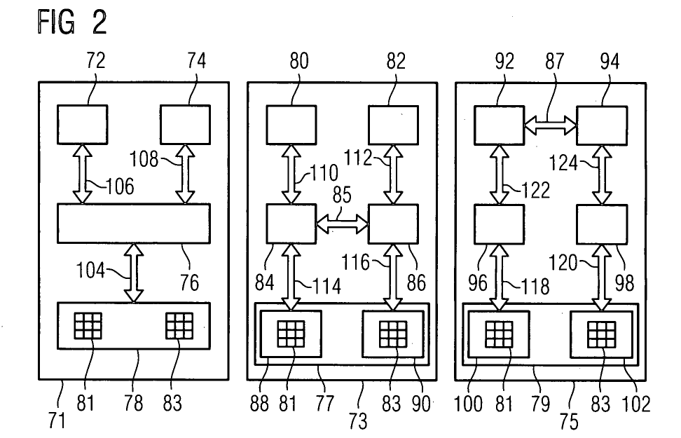

FIG. 2 shows a schematic representation of exemplary embodiments of an image processing apparatus. An image processing apparatus 71 is shown. The image processing apparatus 71 comprises a processor 72, a processor 74, a memory controller 76 and a shared memory 78. The processor 72 is connected to the memory controller 76 by way of a connection 106. The processor 74 is connected to the memory controller 76 by way of a connection 108. The memory controller 76 is connected to the shared memory 78 by way of a connection 104. An image data record 81 and a 2D output image data record 83 are shown, which are stored by a shared memory 78. In this embodiment of the image processing apparatus 71, the processor 72 is able to access the shared memory 78 and there the image data record 81 via the connection 106 and the memory controller 76 and the connection 104 and is able to read this out from the shared memory 78 via the memory controller 76—in the reverse signal path direction—and is able to generate the output image data record 83 from the image data record 81 in accordance with a predetermined allocation specification and is able to store this in the shared memory 78 by way of the memory controller. The processor 74 is able to access the shared memory 78 by way of the connection 108, the memory controller 76 and the connection 104, and is able to readout the output image data record 83 for instance and generate a further output image data record in accordance with a predetermined allocation specification. The processors 72 and 74 can each access the shared memory 78, controlled by the memory controller 76.

The predetermined allocation specification can include an algorithm, comprising a number of computing steps. Each computing step can correspond to its own predetermined allocation specification.

An image processing apparatus 73 is also shown. The image processing apparatus 73 comprises a processor 80, a processor 82, a memory controller 84, a memory controller 86, a memory unit 88 and a memory unit 90. The memory units 88 and 90 form a shared memory 77 in each instance. The shared memory 77 can be formed for instance by a coherent address space, formed by the memory units 88 and 90. The memory units 88 and 90 can each be formed by a memory module in each instance. The memory modules can be spatially distanced from one another in each instance. The processor 80 is connected to the memory controller 84 by way of a connection 110. The processor 82 is connected to the memory controller 86 by way of a connection 112. The memory controller 84 is connected to the memory unit 88 by way of a connection 114 and can access said memory unit 88. The memory controller 86 is connected to the memory unit 90 by way of a connection 96 and can access this. The connection 96 and the connection 114 can be formed for instance by an infini band or by a hyper transport or a fiber channel. With the image processing apparatus 73, the memory controllers 84 and 86 are connected to one another by way of a connection 85. This enables the processor 80 to access the memory unit 90 of the shared memory 77 by way of the memory controller 84, the connection 85, the memory controller 86 and the connection 96. The processor 82 can access the memory unit 90 on a direct signal path, via the connection 112, the memory controller 86 and the connection 96. The processor 82 can also access the memory unit 88 via the connection 112, the memory controller 86, the connection 85, the memory controller 84 and the connection 114. The image data record 81, which is stored by the memory unit 88, is shown. The output image data record 83, which is stored by the memory unit 90, is also shown. In this embodiment, the processors 80 and 82 can thus access the memory units 88 and 90 formed by the shared memory 77 by way of a connection 85, which connects the memory controller 84 and the memory controller 86.

An image processing apparatus 75 is also shown. The image processing apparatus 75 comprises a processor 92, a processor 94, a memory controller 96, a memory controller 98, a memory unit 100 and a memory unit 102. The processor 92 is connected to the memory controller 96 by way of a connection 122. The memory controller 96 is connected to the memory unit 100 by way of a connection 118. The processor 94 is connected to the memory controller 98 by way of a connection 124. The memory controller 98 is connected to the memory unit 102 by way of a connection 120. In this exemplary embodiment of the image processing apparatus 75, the processors 92 and 94 are connected to each other by means of a connection 87. The image data record 81, which is stored by the memory unit 100, is shown. The 2D output image data record 83, which is stored by the memory unit 102, is also shown. The memory units 100 and 102 collectively form a shared memory 79. The memory units 100 and 102 can be embodied in each instance as a memory module, the shared memory 79 can be formed by a common, coherent address space of the memory units 100 and 102. The memory units 100 and 102 can be arranged spatially distanced from each other in each instance. The connection 118 and the connection 120 can each be embodied as an infini band channel or as a hyper transport channel. The processor 92 can thus access the shared memory 79 by way of the memory controller 96 and there access the image data record 81. The processor 94 can access the shared memory 79 by way of the connection 87, the processor 92 and the memory controller 96 and there access the memory unit 100 and thus the image data record. The processor 92 can access the shared memory 79 by way of the connection 87, the processor 94, the memory controller 98 and store there the 2D output image data record in the memory unit 102. The processor 92 can thus access the memory unit 100 via the memory controller 96 and can thus access the memory unit 102 of the shared memory 79 by way of the connection 87, the processor 94 and the memory controller 98. The processor 94 can access the memory unit 102 by way of the memory controller 98 or can access the memory unit 100 of the shared memory 79 by way of the connection 87, the processor 92 and the memory controller 96.

The processors of the image processing apparatuses 71, 73 and 75 can each form an image processing unit, in particular collectively with the computing program.

The connections 85, 87, 104, 106, 108, 110, 112, 114, 116, 118, 120, 122, 124 can each be embodied as an Infini-Band- or as Hyper-Transport- or as Fiber-Channel-connection, as a PCI-Bus or as a PCI-Express-Bus.

1.-11. (canceled)

12. An image processing system having an image processing apparatus for processing an image data record of an object, comprising:
a plurality of image processing units that receive a temporal sequence of image data records of the object and generate output image data records from the image data records; and
a shared memory assigned to the image processing units that stores the image data records and the output image data records so that the image data records and the output image data records are accessible to the image processing units.

13. The image processing system as claimed in claim 12, wherein each of the image processing units comprises a computing unit comprising one processor, one core of a multi-core processor, one cell processor, one digital signal processor, or one field programmable gate array.

14. The image processing system as claimed in claim 12, wherein the shared memory comprises a coherent address space.

15. The image processing system as claimed in claim 12, wherein at least one of the image processing units comprises a computing unit that generates the output image data records based on a predetermined allocation specification.

16. The image processing system as claimed in claim 12, wherein the image processing apparatus comprises a cache memory that is assigned to the shared memory.

17. The image processing system as claimed in claim 12, wherein the image processing apparatus comprises a memory controller that connects the image processing units to the shared memory.

18. The image processing system as claimed in claim 12, wherein the shared memory comprises at least two memory units each being connected to one of the image processing units by a memory controller.

19. The image processing system as claimed in claim 12, wherein the shared memory is connected to the image processing units in accordance with a NUMA architecture.

20. The image processing system as claimed in claim 12, wherein the image processing units are connected to the shared memory by a Remote-DMA-System.

21. The image processing system as claimed in claim 12, wherein the temporal sequence of image data records creates a data stream.

22. A method for processing a temporal sequence of image data records of an object, comprising:
receiving the image data records by a plurality of image processing units;
generating output image data records from the image data records by the image processing units;
connecting the image processing units to a shared memory; and
storing the image data records and the output image data records in the shared memory; and
processing the image data records by the image processing units via accessing the image data records and the output image data records.

23. The method as claimed in claim 22, wherein the image data records represent the object in at least two dimensions.

24. The method as claimed in claim 22, wherein the image data records are processed by at least two processing stages.

25. The method as claimed in claim 22, wherein the output image data records is generated based on a predetermined allocation specification.

26. The method as claimed in claim 22, wherein the image processing units are connected to the shared memory by memory controllers.
